(19) United States
(12) Patent Application Publication
(10) Pub. No.: US 2001/0007392 A1
(43) Pub. Date: Jul. 12, 2001

(54) Holder device for hand-held instruments

(76) Inventor: Steven Sugarman, Pontprennau (GB)

Correspondence Address: Thomas D. Paulius, VEDDER, PRICE, KAUFMAN & KAMMHOLZ, 24th Floor, 222 North LaSalle Street, Chicago, IL, 60601, US

(21) Appl. No.: 09/747,743

(22) Filed: Dec. 22, 2000

(30) Foreign Application Priority Data
Jan. 8, 2000 (GB) 0000303.8

(51) Int. Cl. B43K 23/00

(52) U.S. Cl. 294/25

(57) ABSTRACT

A one-piece device of elastomeric material for holding an instrument 20 such as a pen on a wearer's hand comprises a strap 10 for attaching around the wearer's hand and a formation 11 on the strap for engaging the instrument 20. In use, the band is slipped over the user's fingers and around the palm of the hand.

The device is arranged such that the pen or other instrument 20 is normally held over the back of the wearer's hand, leaving the wearer's fingers free to perform tasks. However, in order to use the pen or other instrument 20, the wearer merely brings the pen or other instrument down between the thumb and forefingers of the hand, whereupon the instrument can be used normally.

Once the wearer has finished with the pen or other instrument, it is released whereupon it returns to the stored position over the hand under the resilient bias of the elastomeric material. In this manner the pen or other instrument 20 is never out of sight and is always to hand when performing other tasks.

### BACKGROUND OF THE INVENTION

This invention relates to a holder device for writing and other kinds of hand-held instruments.

Many tasks require a pen, pencil or other writing implement to be continuously to hand. However, it is relatively easy to misplace the instrument between successive uses.

The use of computers is widespread and it is envisaged that conventional data input devices such as keyboards and mice will be replaced by hand-held electronic instruments in the form of a pen. Indeed, such instruments are already used in some applications such as CAD systems.

Accordingly, it would also be desirable to have such electronic instruments continuously to hand.

### SUMMARY OF THE INVENTION

I have now devised a holder device for a hand-held instrument, which enables the instrument to be continuously kept to hand.

In accordance with this invention, there is provided a holder device for a hand-held instrument, the device comprising a strap for attaching around the user's hand and means on the strap for engaging a hand-held instrument, wherein the instrument engaging means is moveable between a stored position and a writing position against a resilient bias.

In use, the band is slipped over the user's fingers and around the palm of the hand. A pen or other instrument is then attached to the instrument engaging means on the strap.

The holder device is attached such that the pen or other instrument is normally held over the back of the hand, leaving the user's fingers free to perform tasks. However, in order to use the pen or other instrument, the user merely brings the pen or other instrument down between the thumb and forefingers of the hand, whereupon the instrument can be used normally.

Once the user has finished with the pen or other instrument, it is released whereupon the pen returns to the stored position over the hand under the resilient bias.

In this manner the pen or other instrument is never out of sight and is always to hand when performing other tasks.

Preferably, the instrument engaging means comprises a passageway into which the instrument can be inserted.

Preferably, the passageway is connected to the strap by a bridge which positions the pen or other instrument away from the strap.

Preferably, the bridge is resiliently flexible to allow the pen or other instrument to be moved from the stored position to the in use position.

Preferably, the holder device is a one piece formation of elastomeric material.

Preferably, the through axis of the passageway is both twistable and pivotable relative to the longitudinal axis of the strap. Preferably the through axis of the passage normally extends substantially perpendicular to the longitudinal axis of the strap.

The strap may comprise a fastener at opposite ends thereof for fastening the strap around the hand. Alternatively, the strap may be a continuous band, into which the user's hand can be inserted.

Also in accordance with the invention, there is provided an assembly comprising a handheld instrument in combination with a holder device therefor, the latter comprising a strap for attaching around a hand and means on the strap with which the instrument is engaged, the holder device being arranged such that the instrument is moveable between a stored position and a writing position against a resilient bias.

### BRIEF DESCRIPTION OF THE DRAWINGS

An embodiment of this invention will now be described by way of example only and with reference to the accompanying drawings, in which:

FIG. 1 is a perspective view of an instrument holder device in accordance with this invention; and,

FIG. 2 is a perspective view showing the holder device of FIG. 1 when in use.

### DESCRIPTION OF THE EMBODIMENT SHOWN IN THE DRAWINGS

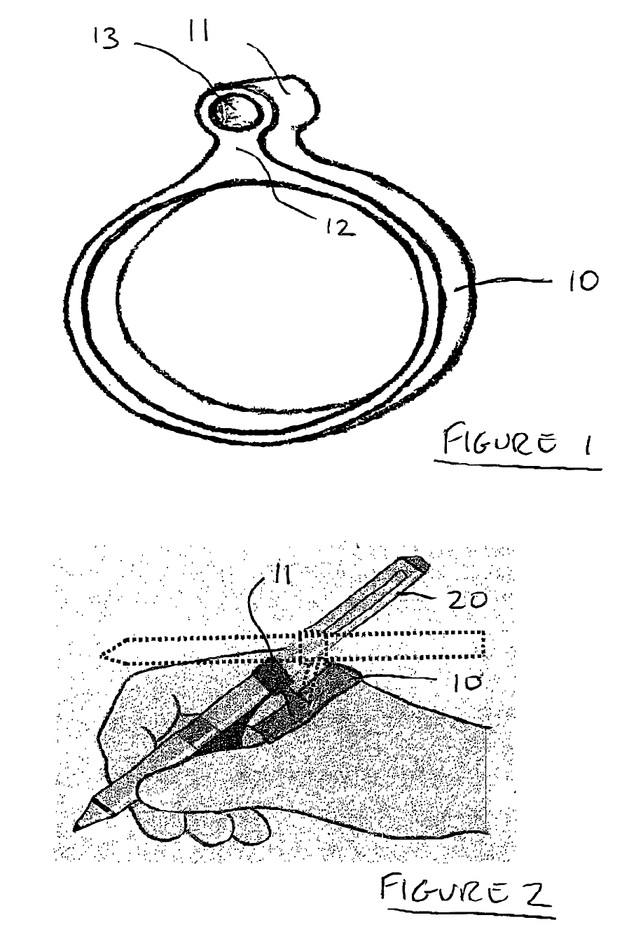

Referring to FIG. 1 of the drawings, there is shown one-piece holder device of elastomeric material for holding hand-held instruments.

The holder device comprises a band portion 10 of sufficient size to enable the band to be stretched and slipped onto the user's hand. A tubular instrument engaging portion 11 is connected to the band portion 11 by means of a bridge portion 12.

The axis of the passageway 13 through the instrument engaging portion 11 extends perpendicular to the longitudinal axis of the band portion 10.

Referring to FIG. 2 of the drawings, in use a pen or other elongate instrument 20 is inserted through the passageway 13 in the instrument engaging portion 11.

The band portion 10 is then slipped onto the user's left or right hand as appropriate, until it is located around the palm of the hand. The bridge portion 12 of the holder device is positioned over the point of the hand between the thumb and index finger.

When the pen 20 is released, the holder device recovers its shape and brings the pen 20 into a position over the back of the hand, where it extends substantially axially of the user's index finger.

However, when the pen is required, the user either has to bring the tip of the pen down between the thumb and forefingers by reaching upwardly using the thumb and index finger or by using the other hand. It will be appreciated that the bridge portion 12 is sufficiently flexible to enable the pen 20 to be moved in any direction whilst writing.

When the user has finished using the pen 20 it is released, whereupon the holder device recovers its shape and the pen is returned to the stored position over the back of the user's hand, where it is out of the way of the user's fingers so that other tasks can be performed but is yet conveniently to hand as soon as it is required.

I claim:

1. A device holding a hand-held instrument, the device comprising a strap for attaching around the user's hand and means on the strap for engaging a hand-held instrument, wherein the instrument engaging means is moveable between a stored position and a writing position against a resilient bias.

2. A device as claimed in claim 1, in which the instrument engaging means comprises a passageway into which the instrument can be inserted.

3. A device as claimed in claim 2, in which the passageway is connected to the strap by a bridge which positions the instrument away from the strap

4. A device as claimed in claim 3, in which the bridge is resiliently flexible.

5. A device as claimed in claim 1, formed as a one piece formation of elastomeric material.

6. A device as claimed in claim 1, in which the through axis of the passageway is both twistable and pivotable relative to the longitudinal axis of the strap.

7. A device as claimed in claim 1, in which the through axis of the passage normally extends substantially perpendicular to the longitudinal axis of the strap.

8. A device as claimed in claim 1, comprising a fastener at opposite ends of the strap around the hand.

9. A device as claimed in claim 1, in which the strap comprises a continuous band, into which the user's hand can be inserted.

10. An assembly comprising a hand-held instrument in combination with a holder device therefor, the latter comprising a strap for attaching around a hand and means on the strap with which the instrument is engaged, the holder device being arranged such that the instrument is moveable between a stored position and a writing position against a resilient bias.
